(19) United States
(12) Patent Application Publication
(10) Pub. No.: US 2020/0364680 A1
(43) Pub. Date: Nov. 19, 2020

(54) Cryptocurrency with Royal Network, Decentralized Trusted Party and Automated Smart Contracts

(71) Applicant: Ilya Gazman, Jersey City, NJ (US)

(72) Inventor: Ilya Gazman, Jersey City, NJ (US)

(21) Appl. No.: 16/416,243

(22) Filed: May 19, 2019

(51) Int. Cl. G06Q 20/06; G06Q 20/38; G06Q 20/36

(52) U.S. Cl. CPC G06Q 20/0658; G06Q 2220/00; G06Q 20/3678; G06Q 20/389

(57) ABSTRACT

Confidence coin, in short Coco, is an upgrade to the cryptocurrency technology, it replaces P2P network with Royal Network and using a special block encoding that together allows blocks as big as Gigabytes of data. It offers micro and macro transactions via Decentralized Trusted Parties. It also increases users privacy and helps government regulators to protect the system from illegal trades and fraudulent activities. Coco upgrades smart contracts to Automated Smart Contracts that allow automatic payments. And it has a leadership organization, founded by Coco system itself with a single purpose of making Coco great.

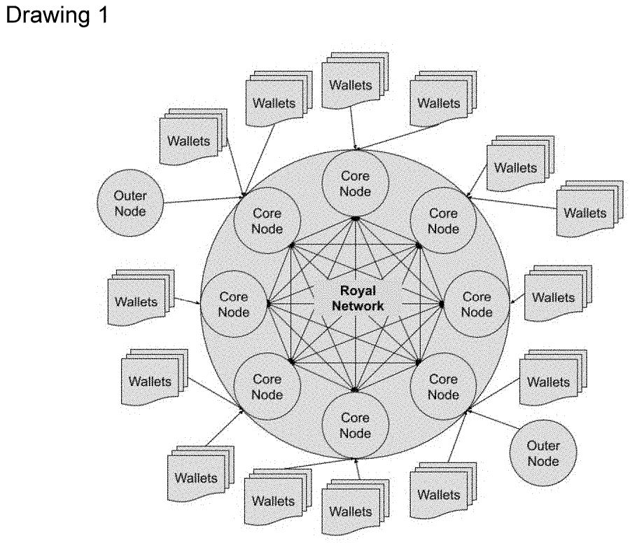

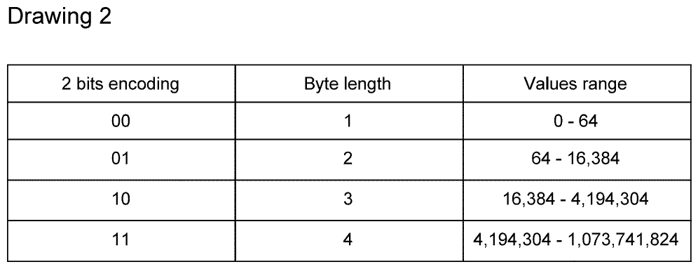

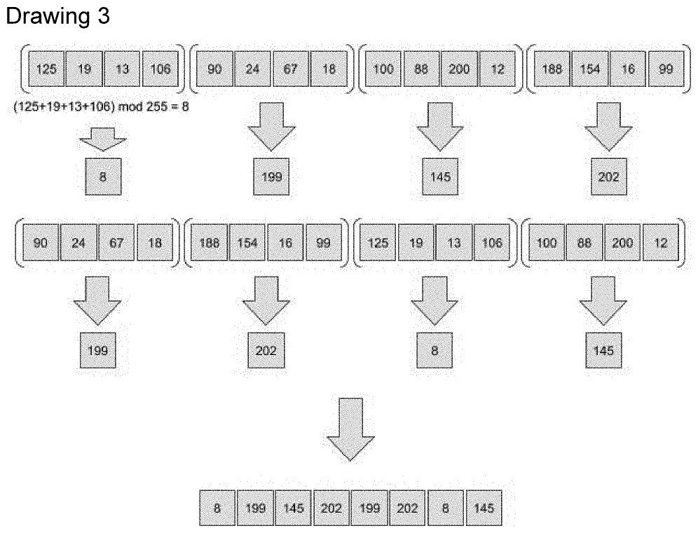

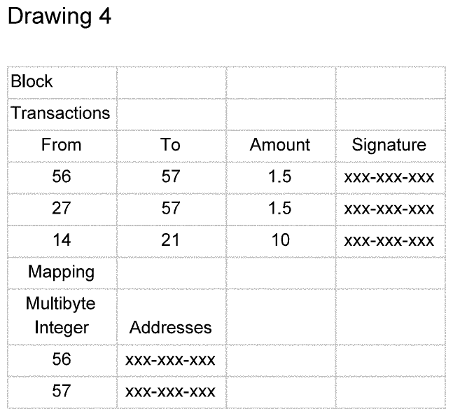

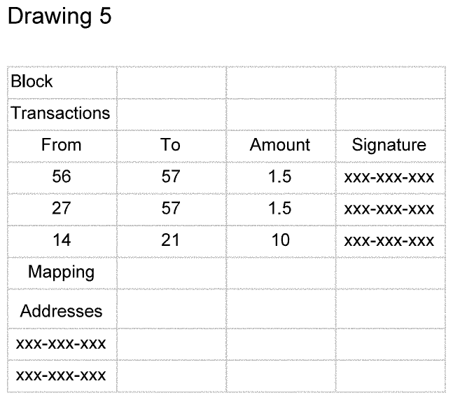

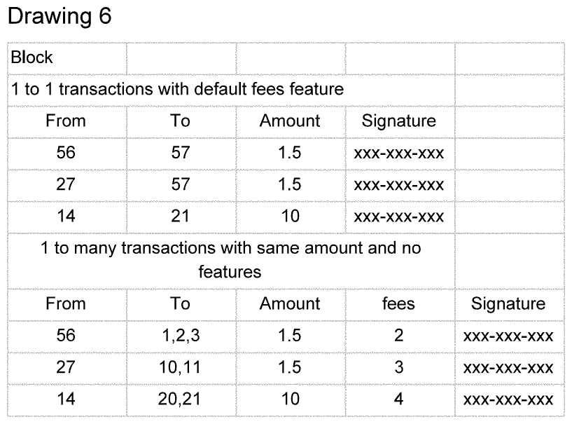

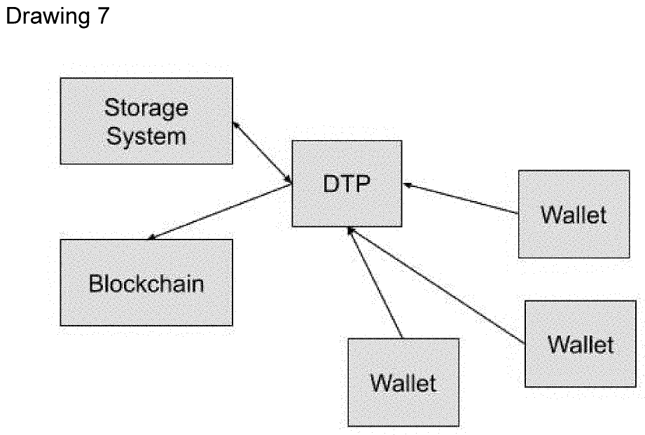

### BACKGROUND

Blocks are data units that store all the information in the cryptocurrency system, such as transactions, smart contracts, and more. Multiple blocks are created every day via a process called mining; it signs the blocks by solving a hard cryptographical problem of partial hash collisions. Each block has a hash signature of the previous block, and together they form a blockchain.

With an increased difficulty of mining blocks, most miners use pools. A pool is an organization that correlates the miners. It combines their mining power and increases the chance of mining a block. Once a pull mines a block it splits the reward among all its miners. Usually, the pool also takes a fee for its services.

Communication in cryptocurrencies systems implemented using peer to peer connection. Each node/peer is responsible for collecting all the transactions and mining the next block, once a peer mines a new block or it wants to perform a transaction it broadcast those events to the rest of the network. A time it takes for those events to propagate through the entire network determinates the network speed, with each new peer added to the network the speed is reduced as there are more nodes to travel. Also, there is no restriction for joining the network and peers with different equipment standards are depended on each other resulting in father decrease of the speed. On top of that, with increasing popularity of cryptocurrencies, the number of transactions increases, resulting in bigger block sizes and even more reduce the network speed.

Today the cryptocurrencies do not support microtransactions. Due to the relatively high transactions fee amount, it's not possible to purchase low-cost products as the fee itself can sometimes go over $10.

The amount can be smaller in nonpopular cryptocurrencies, but there is no promise it will stay that way.

Smart contracts are scripts that can execute transactions, save data in the blockchain, and more.

In cryptocurrencies today, execution of smart contracts is triggered by transactions that contains the smart contract script. Its not possible to schedule a future payment or repeated payment via those smart contracts, so it's impossible to implement subscriptions payments or future payments using those cryptocurrencies alone.

There is no solution as part of the cryptocurrencies mechanism to allow government regulators to protect cryptocurrency users from illegal trades and fraudulent activity. There is no way to make transactions and wallets owners to be visible for governments regulators but not publicly available for everyone.

No mechanism in cryptocurrency returns lost coins back to circulation.

If someone lost access to his wallet, his coins would become inaccessible forever.

Creating a new community and new cryptocurrency is not an easy task. It requires resources and dedication. Almost everyday new cryptocurrency emerge to the world, but with limited resources, they quickly vanish.

### BRIEF SUMMARY

Coco is a cryptocurrency system that offers a solution to the problems mentioned in the background section and more.

Until today trusted parties and cryptocurrency decentralization considered to be opposites, however, Coco found a way to combine those two different approaches into what Coco calls: Decentralized Trusted Party, DTP.

DTP is a way to make off-chain transactions over Coco. It significantly reduces the transactions fees to the point where microtransactions are possible.

Users in Coco can entrust their wallet to other users by sending a Trust-Transaction from wallet A to wallet B. The owner of wallet B can now perform transactions on behalf of wallet A. However wallet B does not get wallets A private key. Also, wallet A owner can rework wallet B owner access to his wallet by sending a termination transaction.

To better understand this idea, let's see examples of its implementation.

Let's assume that V is a major credit card company that wants to form a DTP, for simplicity let's keep calling it V. V share it's Coco wallet with its users and allow them to entrust V with their wallets. From this point, users will make their transactions via V. However V will not instantly perform a transaction over the blockchain, it will save the transactions, and after some time it will aggregate all the transactions and make an update transaction over the blockchain.

Update-Transaction is a unique transaction that can only be performed by a DTP. At once, it updates the balance of multiple wallets in the system. DTP is only required to provide its signature, and for each wallet it updates, it just needs to provide a wallet address and the new balance. When miners validate this transaction they will check that the total number of coins in the system didn't change, meaning that the Update-Transaction only moved coins between the wallets in the transaction, but no coins were lost, and no coins were gained.

An Update-Transaction of 1,000,000 wallets that made an unlimited amount of transactions between them self will take between 3.8 to 11.4 MB of block space; It's by order of magnitude smaller compared to other cryptocurrencies.

When wallet sends a termination transaction to rework other wallet access, it's not happening instantly but instead just saved to the blockchain. If the DTP does not perform an update transaction within a period of predefined time(best one month), it will be reworked without committing the transactions to the blockchain, and one will be able to double spend his coins! Therefore to prevent this from happening, the DTP is obliged to perform an update transaction at least once a period.

Using DTP is beneficial for many perspectives

Since the DTP manages the transactions, it's possible to charge the fees from the seller rother then the buyer in a similar way as it works with today's credit cards.

DTP doesn't need banks to hold the actual coins. Coco owns the coins so that DTP can enjoy more independence.

At any point of time, DTP does not hold the costumer coins, therefore if DTP will try to commit some sort of fraudulent activity the customer will be able to spot it right away as any transaction in the real coins is made using Coco over the blockchain, and it's visible to everyone.

Since DTP managing other people coins, it must allow the government to regulate all the transactions made through it. And so the government is protecting the merchants and the customers from illegal trades and fraudulent activity.

Unlike the transactions made over the blockchain the transactions made with DTP do not reveal the origin nor the destination of the transaction, it provides more privacy both to customers and merchants.

DTP is fantastic, but it will be infeasible to implement while the block size is limited, as the periodic update transaction can consume a lot of space.

Coco makes two significant upgrades to the cryptocurrency technology to increase the block size: Coco Royal Network and special block encoding that map the wallet address to a multibyte integer and aggregates similar transactions.

First about the Royal Network. The Royal Network is formed from peers in the last blocks. Ws a small predefined number that allows all the nodes to have a direct connection one to another (best 200).

To join the Royal Network one need to have a huge mining power to be able to mine a block and keep mining them, and be resourceful enough to maintain a server that serves all the wallets in the system.

The most significant benefit of such network is the broadcasting speed, the resourcefulness of the peers allow them to use the best technology money can buy and since they have a direct connection the block size can be dramatically increased.

Now the special encoding. When new wallet address appears in a block for the first time, it's mapped to a consecutive multibyte integer starting from a small predefined number(best 1), so when wallets make trust transactions, their address is being mapped and during the update transaction only the multibyte integers are used. With 32 bytes as a relatively short wallet address, it provides 8 to 32 times reduction for the first billion registered wallets. The special encoding also aggregates transactions by type and features. One of such features is a replacement of 8 bytes transaction amount with a multibyte float. It allows father reduction of all the amounts in the update transaction by up to 8 times.

The Royal network, together with the special block encoding, allows having enormous block sizes and ability to processes many update transactions in a single block.

Coco uses Automated Smart Contracts that offer several benefits over the traditional cryptocurrencies Smart Contracts. Cocos Automated Smart Contracts can be triggered by time, like crone jobs in Unux and by incoming transactions, it makes it possible to implement subscription services and third party fee systems.

The Automated Smart Contracts comprising: Model, a modifiable data submitted along with the Automated Smart Contract, and; a script that is invoked by the nodes of the Royal Network each time the smart contract is executed.

When an Automated Smart Contract is executed, it can perform the following actions:
Read and write its model data
Read blockchain data
Move coins from the wallet that created it to any other wallet.

The Automated Smart Contracts executed when new blocks are mined, wallets can create an unlimited number of Automated Smart Contracts. Also, wallets can create an Automated Smart Contract as a copy of existent automate smart contract. It allows reducing the size of the block for those requests.

Here are a few examples of Automated Smart Contracts usage: A game admin creates an Automated Smart Contract that upon execution moves coins(game subscription fee) from the wallet who created the smart contract to the game admin wallet only if it's the first of the month and no payment for this month have been made. A user subscribes to the game by creating a copy of that Automated Smart Contract. The game admin sees the user Automated Smart Contract in the blockchain and gives her access to the game. Now every first of the month, the user will be charged with the game subscription fees. Those fees are automatically charged and don't consume additional block space. At some point in the future, the user deactivates her smart contract, the game admin see that in the blockchain and revoke her access to the game.

Another use case is Clark and Lois that open an ice cream business where they split their earnings evenly 50/50. Clark creates an automated contract that sends 50% from every incoming transaction to Lois wallet. So each time a customer buys an ice cream and sends a coin transaction to Clark wallet, 50% of the costumer coins are sent to Lois wallet.

Coco systems provide two ways to preserve the coins in the system and prevent loss. Coco transactions are set to expire within a predefined number of blocks from the moment of their creation(best 6). It helps to keep the transactions queue size small and prevents unexpected transaction execution. It also helps to reduce the block size as there is no need to provide a transaction serial number; transactions of those last blocks are locally saved and cannot be executed more than once.

Every few years(best three) all the wallets who did not make any transaction by them self or via DTP will be considered as lost, and their balance will be added towered the blocks reward system. This way, even if someone lost his private key to a wallet with coins, those coins will not be lost, and the circulation will not be affected.

Coco has a leadership organization that is founded by Coco system when a new block is discovered a small portion of the block reward(best 1%) goes to leadership organization wallet. The leadership organization will use those funds to develop and maintain Coco. It increases the chance of making Coco into major cryptocurrency.

### DETAILED DESCRIPTION

At first, I will describe the structure and the encoding of the components in the system, and then I will show the flow that will demonstrate the connection between the components.

### System Structure

Look at drawing 1. The system is built from pools and wallets.

pools are the core nodes in the Royal Network. Their number is limited to 200, and each of them can have an unlimited amount of wallets connected to it. Each wallet communicates with only one pool.
The pool is responsible for the creation of blocks, and broadcasting transactions. pool maintains the system model in a database that has all the information of the blockchain, such as wallets balances, Automated Smart Contract and more.
The wallet is the client-side program. It's responsible for the creation of wallet public and private keys, making transactions and mine coins. It communicates with the pool to fetch wallet balance, broadcast a transaction or submit a mining job.

### Wallet Address

Wallet encryption is done using Curve25519, for its fast processing speed and a short signature, only 64 bytes. Curve25519 public key is a wallet address.

### Block Encoding

### Base Types

### Multibyte Integer—MI

There are several ways to implement multibyte integers, in Coco they are at most 4 bytes big-endian of data where the first 2 bits of the first byte are used to represent the byte length of the integer, see drawing 2 for details.

### Multibyte Floating Point—MFP

There are several ways to implement multibyte floating points, in Coco they are numbers in a range of 0-10.73741823 inclusive, those numbers are multiplied by 100,000,000, rounded using Floor and encoded into at most 4 bytes MI as described above.

### Hash

32 bytes computed using SHA-256

### Signature

64 bytes signature computed with Curve25519

### Block Structure

1. Header
2. Lists
3. Footer

### Header Structure

1. Block Id—Incremental MI value starting from 94
2. Difficulty—Hash
3. Core version UUID—16 bytes universally unique integer
4. Pool domain address
   a. Domain byte length MI
   b. UTF-8 formatted domain address
5. Transaction fees—8 bytes floating point value the total transaction fees
6. Smart contract fees—8 bytes floating point value the total smart contract fees
7. Reward—MI block reward
8. Reward Id—MI, the wallet id to where 99% of the Reward, transaction fees, and smart contract fees will be sent
9. Leadership reward id—MI, the wallet id of the leadership organization where 1% of the block reward will be sent
10. Smart contract execution—Hash
11. Previous block—Hash of the previous block

### Footer

1. Job Id—1 bytes—A blob value that the pool generates to prevent mining collisions between the miners of the pool
2. Mined date—8-byte integer, milliseconds epoch time
3. Blob—8 byte or random data that the miners use to manipulate the block hash
4. Block hash—Hash, the solution to the hash collision problem within the block difficulty

### Lists Structure

Each list has the below structure
Type—MI list type
Block id—MI block id
Features—1 Byte feature bitmask
Count—MI, number of items in the list
items body

### List Types

The possible values for list types
1. 1 to 1 Transaction
2. 1 to many Transactions with same balance
3. 1 to many Transactions with different balance
4. Smart Contracts
5. Smart Contracts applications
6. Trusts
7. DTP: Balance update
8. List group
9. Addresses list

### List Features

The possible values for list features
1. Microtransaction: If “on” the coin transactions amount will be encoded with MFP. if “off” the amount will be 8 bytes floating point.
2. Default transaction fee: If “on” the transaction fees will be a hardcoded value and will not appear in the transaction if “off” the transaction fees will be encoded with MI
3. Trusted signature: If “on” the signature will be omitted. Only valid in Lists group

### 1 to 1 Transaction

Sender signature
Sender id, MI
Receiver Id, MI
Amount as specified in the feature bitmask
Transaction fees as specified in the feature bitmask
   1 to Many Transactions with Same Balance
1. Sender signature
2. Sender id—MI
3. Receivers count—MI
4. Receivers—Each is
   1. Receiver id—MI
5. Amount as specified in the feature bitmask
6. Transaction fees as specified in the feature bitmask
   1 to Many Transactions with Different Balance
1. Sender signature
2. Sender id—MI
3. Receivers count—MI
4. Receivers—Each is
   1. Receiver id—MI
   2. Amount
5. Transaction fees as specified in the feature bitmask

### Automated Smart Contracts Creation

CreatorId—MI wallet id of the contract creator
Model data size—MI model data byte size
Model data—Model data size bytes
script size—MI script size
script—MI script size bytes
Creator signature

### Automated Smart Contracts Copy Creation

CreatorId—MI wallet id of the contract creator
Automated Smart Contracts Id, MI
Creator signature

### Trusts

Sender id, MI
DTP wallet id, MI
Termination hours time, MI. A value of zero indicates to start termination
Sender signature

### DTP: Balance Update

DTP id—MI
Updates—Each is
   Id-MI
   Balance as specified in the feature bitmask
DTP signature

### List Group

DTP id
Lists—From the lists above
DTP signature

### Addresses List

Public key wallet addresses

### Wallet Transaction Encoding

The wallet uses a simpler encoding structure. The pool will convert it to block encoding structure in such a way that it's possible to convert it back to the wallet encoding structure. The validation of wallet signature needs to be done using wallet encoding structure.
Amount—8 bytes floating point value
Block hash—The Hash value of the last known block.
Sender public key—32 bytes, the pool will replace it with wallet id, so the wallet does not need to maintain addresses database.
Receivers list count—Integer number of the receivers
For each receiver
   Receiver wallet public key—32 bytes
   Amount—8 bytes Floating point value the amount sent to that receiver
Transaction fees—8 bytes floating point value, fee amount for this transaction
Signature—64 bytes

### Mining Process

This is a step by step process to compute a block hash
I. Compute SHA-256 of the first two parts of the block: Header, Lists
II. Generate job id 16 bytes
III. Concatenate the results from step I and II and compute SHA-256 of them
IV. Concatenate the current time step(8 bytes milliseconds epoch time) with the result from ii and compute SHA-258 of them
V. Compute SHA-256 of the blob
VI. Take the result of V, it's 32 bytes, sum every 4 bytes to one as seen in Drawing 3, so you get 8 bytes and convert it to Java long type
VII. Use the previous result(Step VI) to pre-seed a Java.Util.Random and compute random.nextInteger(5)
VIII. Use the previous result(Step VII) to select a hashing algorithm from the list below and use it to compute the blob hash again
   0. MD5
   1. SHA-1
   2. SHA-384
   3. SHA-512
   4. MD5
IX. Concatenate the result from step IV, V and VIII and compute SHA-256 from them
X. If the result from IX is smaller than the difficulty submit a new block, otherwise go back to step IV and try a different blob

### Mining Flow

1. Wallet(Miner) request a mining job from the Pull, the Miner, provides its wallet address.
2. The Pull generates a JobId. It will be used later to reward the Miner.
3. The Pull completes steps I to III of the Mining process.
4. The Pull sends the Miner the result of step III along with JobId and pulls difficulty.
5. The Miner continue the mining process from step IV, each time it solves the block with difficulty provided by the pool, it performs step 6
6. The Miner submits to the pool a solution of the block under the pool difficulty, it sends JobId, blob and Mining Time.
7. The pool calculates the block hash based on the data received from the Miner.
   If the hash solves the block under pools difficulty, it adds one reward point to the Miner
   If the hash also solves the block under the block difficulty, the Pull submits a new block and share the reward with all the miners based on the reward points. The pool also keeps some of the rewards as a service fee for the miners.
8. The pool responds to the miner with the same response as in step 3 to keep the miner up to date with the new blocks that been discovered by the system.

To summarize it, the Miner will continuously keep mining and periodically send hash solutions to the pool, for each such solution the pool will reward the miner and when the solution is good enough also to solve the block, the pool will submit new block.

Each time the Miner is communicating with the pool, it will be updated with the most recent block data so it will mine the right block.

Also, note that in case the Miner had pending reward points from the pool, but another pool solved the block, the reward points will be lost, Miners only get a reward for the blocks they solve.

### Joining Royal Network Flow

In case a new pool would like to join the Royal Network, let's call it pool A, it must first mine a block by its own. To help those pools, the pools provide a protocol where the new pool sends its domain to some other pool, let's call it pool B, pool B replies than with a hash code of step one in the mining process where the domain address is pool A domain.

The incentive for B to implement this protocol is that it keeps its wallet id as the reward address for the block A will mine.

### Block Validation Flow

Once a block was discovered it will go through the below process of validation.

In the below validation tests “new block refers to the block that been tested and Current block” refers to the last block in the blockchain.

### Block Hash Test

The test pass if and only if the new block hash is smaller than the new block difficulty

### Mined Date Test

The test pass if and only if the tested date is before the current date and within 3 min of it. The current date is the date when the test started or the connection with the peer who provided the new block was established.

### Block Id Test:

if the new block id is smaller or equal to the current block id the test fails
If the new block id is greater by more than one, it can only happen when the new block was received from another pool. The pool will go into recovery mode. It will back up the database, drop it and rebuild it from the pool who sent the block. If the recovery process fails, it will fail this test and restore the database from the backup.
If the new block is greater by one from the current block the test will pass.

### Difficulty Test

The expected difficulty is calculated based on the last ten blocks in the blockchain, the test pass if and only if, the new block value match this value.

### Core Version Test

The core version is a hardcoded value. It is used to force hard forks in the system. The test pass if and only if, the new block value match this value.

### Pool Domain Address Test

One of the testers wallets issues a random protocol request to the provided domain, and the response is tested to be valid.

### Reward Test

The test pass if and only if the tested reward amount matches the expected amount

### Reward Id Test

The test pass if and only if the reward Id is a registered wallet id save in the database

### Previous Block Hash Test

The test pass if and only if the new block previous block hash equals to the current block hash

### Leadership Reward Id

The test pass if and only if the leadership reward id matches the hardcoded value

### Transactions+Transactions Fees Test

The test pass if and only if the below conditions are true
All transaction signatures are unique and valid
There is no wallet with a negative balance in the system
The transaction fees in the new block match the expected value
The total amount of coins in the system wasn't changed

### Automated Smart Contracts+Automated Smart Contracts Fees Test

A file is created.
For each each command to move coins coming from Automated Smart Contracts, one line is being written to the file, it contains the information of the amount being transferred and its destination.
Then file Hash is being calculated using SHA-256.
The test pass if and only if the below conditions are true
   Calculated hash value match Automated Smart Contracts execution hash value
   Automated Smart Contracts fees in the new block match the expected value
   The total amount of coins in the system wasn't changed

### DTP Flow

DTP publish its wallet and ask users to sent trust transactions to it with some minimum termination time.
Users sent trust transaction to DTP from their wallet app.
Periodically the DTP makes update transactions to match users balance in DTP to their balance in Coco.

In case DTP needs to make transactions to wallets that did not entrust it, it still can do it in an efficient way using the List Group transaction. The List Group transaction using the same encoding as done in the block and can contain multiple lists inside it, from any type, while the DTP only required providing just one signature, it's own.

### Transaction Flow

Users feel in the transaction details as listed below
Full amount—Will be encoded as 8 bytes integer
At least one recipient's wallet address
Fees: User can either specify a nondefault fee amount or leave it blank to use default fees
The wallet sends a prepare transaction request to the pool
The pool calculate transaction fees and validate the transaction, in case the transaction is valid the pool respond with the full transaction details otherwise it sends the reason why the transaction was invalid
The wallet presents to the user the entire transaction with the exact mining fees
The user can choose to approve or discard the transaction, in case the user accepts it the wallet submit the transaction to the pool
The pool validate the transaction and broadcast it to the other pools
Eventually one of the pools mine the transaction to the block
In case of no pool mine the transaction it will expire after six blocks

### Block Reward Flow

The block reward is calculated as follow:

250—floor(block Id/3188)

The reward starts from 250 coins and every 3188 blocks the reward is reduced by one coin until it reaches 0. The first block id starts from 94. It makes the total coins in the system to 100,000,000 coins.

After the reward reaches 0, the formula will be changed to the one below: min(Total lost coins, 50)

Every block reward will be 50 coins until the lost coins are consumed.

The lost coins are coins collected with the below process:

After the first block, after three years of the last run, starting five years from the first block, the process will run and delete all the wallets who haven't made any transactions for the previous three years, and the DTP didn't update their balance for the last three years. Their balance will be added to lost coins.

1. A cryptocurrency system

2. A system in claim 1 with a Rosyl Network as shown in drawing 1, a network with a method for reaching a consensus for adding and removing nodes using a predefined maximum number of nodes, a PN, comprising: core nodes, and; nodes who wish to join the network, outer nodes;
The outer nodes have information about how to connect to the core nodes;
The outer nodes get block information from the core nodes to start mining blocks; the outer nodes and the core nodes are mining blocks; the outer nodes send their mined blocks to the core nodes; core nodes who mined a block and core nodes who received a block from outer nodes send it to the rest of the core nodes; when a new block is mined, the nodes who mined the last PN blocks become the core nodes and the core nodes who did not mine any of the last PN blocks removed from the network.

3. A system in claim 1 with a method for uniquely mapping wallet addresses to unique consecutive multibyte integers as shown in drawing 4 comprising: a block of a blockchain of the cryptocurrency system; the first block in the blockchain, a genesis block; a plurality of transactions appearing in the block; a plurality of wallet addresses appearing in at least one of the block transactions, and; a mapping information;
Wallet addresses in transactions are uniquely mapped to unique consecutive multibyte integers, starting from the last mapping integer in the previous block and starting from a small predefined number in the genesis block, making all the future references to the mapped wallet addresses in the current block and next blocks to use the multibyte integers.

4. A method in claim 3 where the mapping information only contains the wallet addresses while the unique multibyte integer is equal to the last such integer from the previous block and a predefined small integer in the genesis block, plus the row number as shown in drawing 5.

5. A system in claim 1 with a method for aggregating similar transactions in a block by writing a header that includes transaction type and transaction features as shown in drawing 6.

6. A method in claim 5 with a feature of encoding the transaction amount with a multibyte floating point

7. A method in claim 5 with a feature of having the transaction fees to be a predefined value and not write it to the block

8. A method in claim 5 with “1 to 1 transaction” type wherein there is only one sender and receiver

9. A method in claim 5 with “1 to many transactions with same balance” type wherein there is only one sender and at least two receivers, that are receiving the same amount from the sender, so the amount is only specified once in the transaction.

10. A method in claim 5 with “1 to many transactions with different balances” type wherein there are only one sender and at least two receivers that receive a unique amount from the sender

11. A system in claim 1 where wallets balance is returned to circulation after the wallet wasn't used for a predefined time

12. A system in claim 1 where transactions expire and become invalid after a predefined time

13. Claim 12 where time is calculated using the block count in the blockchain

14. A cryptocurrency system wherein a predefined portion of a reward from mining a block is sent to a predefined wallet.

15. A cryptocurrency system as shown in drawing 7, with a plurality of wallets wherein each wallet can allow and disallow one other wallet at a time to make transactions on its behalf comprising: A plurality of wallets; trust, a permission of a wallet to another wallet to make transactions on its behalf; a plurality of wallets who received trust from other wallets, DTPs; blockchain where the information about trust is stored; update transaction, a transaction made by a DTP on behalf of at least two wallets that trust it, between them self, wherein the wallets addresses and their new balances, and; DTP storage system, a system controlled by a DTP that saves all the transactions made by wallets who trust it between them self via it;
wallets grant trust to a DTP, and; making all its future transactions to other wallets who trust the DTP via the DTP storage system; while the DTP periodically aggregate all the transactions in its DTP storage system; makes an update transaction with total amount of wallets balances equal to the total amount of those balances prior to the update transaction, and; remove all the saved transactions from its DTP storage system.

16. A system in claim 15 where wallets are not allowed to make transactions by them self while trusting a DTP

17. A system in claim 15 where wallets request to disallow a DTP is granted only after at least one of the following condition is met the DTP is making an update transaction; after a predefined time

18. Claim 17 where time is calculated using the block count in the blockchain

19. A cryptocurrency system with smart contracts that executes after each new block, Automated Smart Contracts comprising:
Automated Smart Contracts wherein each Automated Smart Contract comprising: Model, a readable and writable data, and; Script, a set of commands that executes the Automated Smart Contract and can perform any of the following actions: Read data from the blockchain, including Models of other Automated Smart Contracts, modify its own Model, move coins from the wallet that created it to other wallets, and deactivate it self, and; blockchain;
With each new block added to the blockchain, all Automated Smart Contracts are executed

20. Claim 19 where the Automated Smart Contracts move coins only after a predefined block count as it's specified in the automated smart contract

21. Claim 19 where the Automated Smart Contracts move coins only after a predefined time as it's specified in the automated smart contract

22. Claim 19 where the Automated Smart Contracts move coins only after a transaction is made to a predefined wallet as it's specified in the automated smart contract
